(19) United States
(12) Patent Application Publication
(10) Pub. No.: US 2023/0085153 A1
(43) Pub. Date: Mar. 16, 2023

(54) DYNAMIC CELLULAR CONFIGURATION OF TETHERING DEVICE FOR POWER SAVING

(71) Applicant: MEDIATEK INC., Hsin-Chu (TW)

(72) Inventors: Sheng-Kai Chang, Hsinchu City (TW); Wang-Hsin Kuo, Hsinchu City (TW)

(73) Assignee: MEDIATEK INC., Hsin-Chu (TW)

(21) Appl. No.: 17/902,908

(22) Filed: Sep. 5, 2022

Related U.S. Application Data
(60) Provisional application No. 63/243,759, filed on Sep. 14, 2021.

(51) Int. Cl. H04W 48/18; H04W 28/20; H04L 5/00

(52) U.S. Cl. CPC H04W 48/18; H04W 28/20; H04L 5/001; H04W 88/04

(57) ABSTRACT

The present invention provides a controller of a tethering device, wherein the controller includes a tethering manager and a cellular configuration manager. The tethering manager is configured to generating tethering parameters of at least one network interface of the tethering device, wherein the at least one network interface of the tethering device is used to communicate with an electronic device, and the electronic device shares a cellular network of the tethering device via the at least one network interface. The cellular configuration manager is configured to determine a first cellular mode according to the tethering parameters of at least one network interface, to control a cellular modem to use the first cellular mode.

### CROSS REFERENCE TO RELATED APPLICATIONS

This application claims the benefit of U.S. Provisional Application No. 63/243,759, filed on Sep. 14, 2021. The content of the application is incorporated herein by reference.

### BACKGROUND

Tethering is the sharing of a mobile device's Internet connection with other connected devices, and the connection of a mobile device with other devices can be done over wireless LAN (Wi-Fi), over Bluetooth or by physical connection using an Universal Serial Bus (USB) cable. The tethering such as the Wi-Fi tethering (i.e., sharing the Internet connection of a mobile device via its Wi-Fi interface) is a useful functionality and is widely supported on the mobile device, but existing Wi-Fi tethering schemes consume excessive power. For example, if the allowed tethering bandwidth is smaller than a cellular capacity of the mobile device, the actual bandwidth will always be limited by the tethering bandwidth, and the useless bandwidth of the cellular capacity will waste power and computing resource.

### SUMMARY

It is therefore an objective of the present invention to provide a tethering device, which can adjust a cellular mode of the tether device according to the tethering bandwidth, to solve the above-mentioned problems.

According to one embodiment of the present invention, a controller of a tethering device is disclosed. The controller comprises a tethering manager and a cellular configuration manager. The tethering manager is configured to generating tethering parameters of at least one network interface of the tethering device, wherein the at least one network interface of the tethering device is used to communicate with an electronic device, and the electronic device shares a cellular network of the tethering device via the at least one network interface. The cellular configuration manager is configured to determine a first cellular mode according to the tethering parameters of at least one network interface, to control a cellular modem to use the first cellular mode.

According to one embodiment of the present invention, a control method of a tethering device comprises the steps of: generating tethering parameters of at least one network interface of the tethering device, wherein the at least one network interface of the tethering device is used to communicate with an electronic device, and the electronic device shares a cellular network of the tethering device via the at least one network interface; and determining a first cellular mode according to the tethering parameters of at least one network interface, to control a cellular modulator-demodulator (modem) to use the first cellular mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a tethering device according to one embodiment of the present invention.

FIG. 2 is a diagram illustrating dynamic cellular configuration of the tethering mode according to one embodiment of the present invention.

FIG. 3 is a flowchart of a control method of the tethering device according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. The terms “couple” and “couples” are intended to mean either an indirect or a direct electrical connection. Thus, if a first device couples to a second device, that connection may be through a direct electrical connection, or through an indirect electrical connection via other devices and connections.

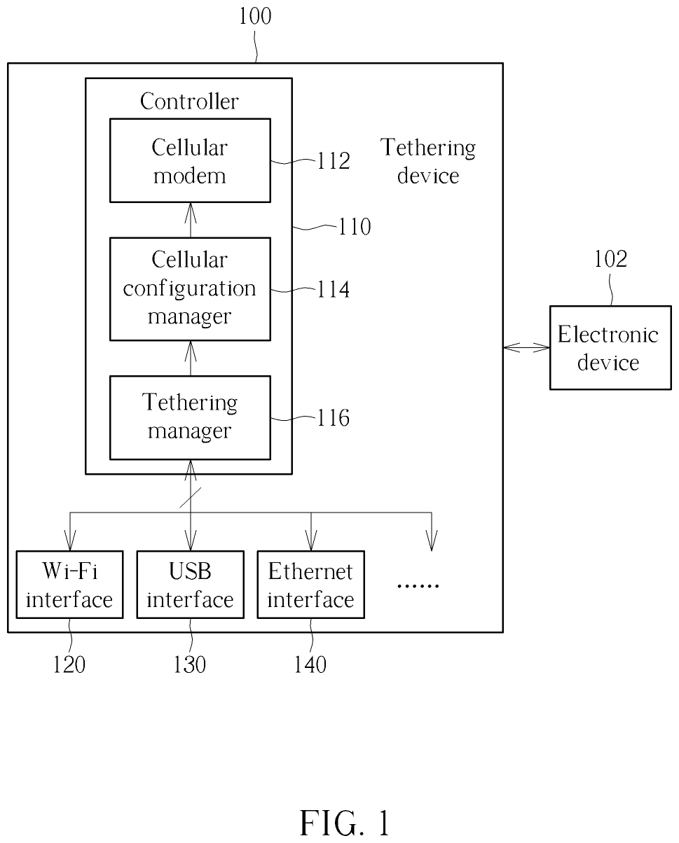

FIG. 1 is a diagram illustrating a tethering device 100 according to one embodiment of the present invention. As shown in FIG. 1, the tethering device 100 comprises a controller 110 and at least one network interface, wherein the controller 110 comprises a cellular modulator-demodulator (modem) 112, a cellular configuration manager 114 and a tethering manager 116, and the at least one network interface comprises a W-Fi interface 120, an USB interface 130, an Ethernet interface 140 or other interfaces such as Bluetooth interface. In this embodiment, the tethering device 100 can be a customer premises equipment (CPE) such as a router, a network switch or a cellular phone; and one or more electronic device, such as an electronic device 102 shown in FIG. 1, can connect to the tethering device 100 via one of the W-Fi interface 120, the USB interface 130 and/or the Ethernet interface 140, and the electronic device 102 can have the network via a broadband cellular network technology of the tethering device 100 such as a fourth generation of broadband cellular network technology (hereinafter, 4G) system or a fifth generation of broadband cellular network technology (hereinafter, 5G) system. In addition, the controller 110 can be implemented by using circuitry within one chip or more chips.

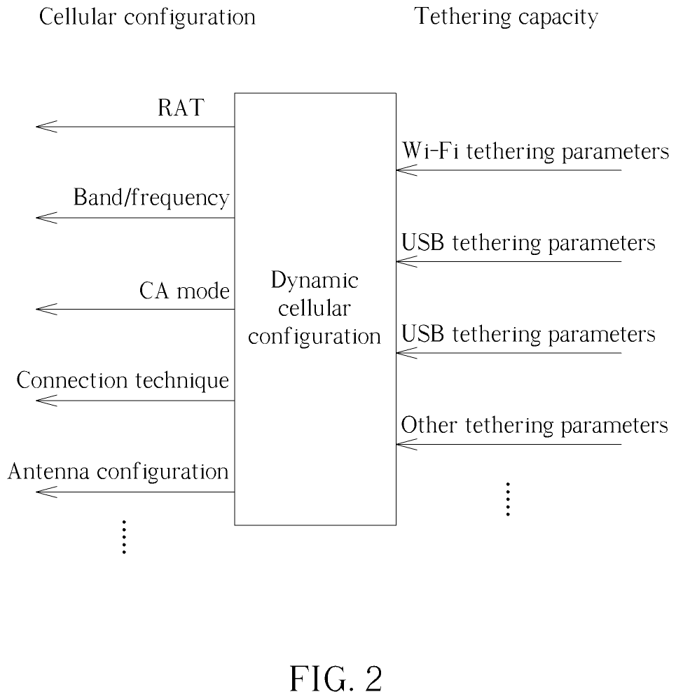

As described in the background of the invention, if the allowed tethering bandwidth (i.e., the bandwidth contributed by the W-Fi interface 120, the USB interface 130, the Ethernet interface 140 and other interfaces) is smaller than a cellular capacity of the tethering device 100, the actual bandwidth will always be limited by the tethering bandwidth, and the useless bandwidth of the cellular capacity will waste power and computing resource. In order to solve this problem, the controller 110 is designed to determine an appropriate cellular mode based on the current tethering capacity/bandwidth of the at least one network interface. Specifically, referring to FIG. 2 together, the tethering manager 116 can provide the tethering parameters to the cellular configuration manager 114, wherein the tethering parameters may be the parameters/capacity of the W-Fi interface 120, the USB interface 130, the Ethernet interface 140 and the other network interface. In this embodiment, the Wi-Fi tethering parameters may comprise an antenna mode (e.g., 1*1 antenna or 2*2 antenna), a bandwidth (channel width) (e.g., 20 Hz, 40 Hz, . . . ) or a band (e.g., 2.4 GHz, 5 GHz, 6 GHz) currently used by the Wi-Fi interface 120; the USB tethering parameters may comprise a connection type (e.g., USB 2.0 or USB 3.0), a speed mode (e.g., low speed, full speed or high speed), or transfer queue parameters (e.g., length/number/priority) currently used by the USB interface 130; and the Ethernet tethering parameters may comprise a cable type (e.g., CAT5/CAT6/CAT7 . . . ), transfer queue parameters (e.g., length/number/priority), and/or if operating in a low power mode for the Ethernet interface 140.

After obtaining the tethering parameters, the cellular configuration manager 114 can determine an appropriate cellular mode, wherein the cellular mode may comprise a RAT, such as 4G system or 5G system, a band/frequency (e.g., sub-6 or mmWave), a carrier aggregation (CA) mode, a connection technique (e.g., discontinuous reception (DRX), sleep mode timer, etc.), and/or antenna configuration (e.g., 2*2 antenna or 4*4 antenna). For example, if only the W-Fi interface 120 is used for the tethering, and the Wi-Fi tethering parameters correspond to a lower bandwidth (e.g., 1*1 antenna with 2.4 GHz), the cellular configuration manager 114 can control the cellular modem 112 to use cellular mode with lower capacity/bandwidth, such as 4G system or 2*2 antenna, to avoid the cellular modem 112 setting a lot of unused bandwidth. In addition, if the Wi-Fi tethering parameters correspond to a higher bandwidth (e.g., 2*2 antenna with 5 GHz), or many network interfaces are currently used for tethering (e.g., all of the Wi-Fi interface 120, the USB interface 130 and the Ethernet interface 140 are used for tethering), the cellular configuration manager 114 can control the cellular modem 112 to use the cellular mode with higher capacity/bandwidth, such as 5G system or 4*4 antenna, to satisfy the requirements of the tethering bandwidth.

In one embodiment, the cellular configuration manager 114 may refer to a look-up table to determine the suitable cellular mode, wherein the look-up table records many combinations of the cellular configuration (e.g., combinations of different RATS, bands/frequencies, and antenna configurations) and corresponding bandwidth, where each combination can be regarded as a cellular mode. The cellular configuration manager 114 can determine the suitable cellular mode by selecting one combination whose corresponding cellular bandwidth is closest to the tethering bandwidth of the tethering device 100, or selecting one combination whose corresponding cellular bandwidth is higher than and closest to the tethering bandwidth of the tethering device 100, wherein the tethering bandwidth can be estimated or calculated by using the Wi-Fi tethering parameters, the USB tethering parameters, the Ethernet tethering parameters, and other tethering parameters.

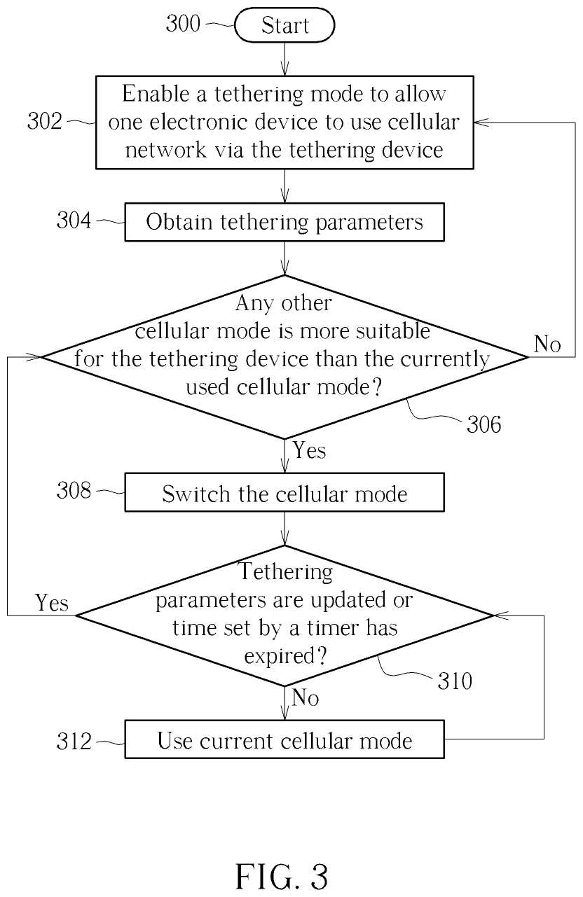

FIG. 3 is a flowchart of a control method of the tethering device 100 according to one embodiment of the present invention. In Step 300, the flow starts, and the tethering device 100 is powered on. In Step 302, the tethering device 100 enables a tethering mode to allow the electronic device 102 to use the cellular network via the tethering device 100. In Step 304, the cellular configuration manager 114 receives the tethering parameters from the tethering manager 116, wherein the tethering parameters may comprise Wi-Fi tethering parameters, the USB tethering parameters, the Ethernet tethering parameters and other tethering parameters. In Step 306, the cellular configuration manager 114 determines whether any other cellular mode is more suitable for the tethering device 100 than the currently used cellular mode, and the cellular configuration manager 114 further determines whether the tethering device 100 is currently suitable for switching the tethering mode, if yes, the flow enters Step 308; and if not, the flow goes back to Step 302. In this embodiment, if the cellular configuration manager 114 can determine another cellular mode whose bandwidth is closer to the tethering bandwidth than the bandwidth of the currently used cellular mode, or if the cellular configuration manager 114 can determine another cellular mode whose bandwidth is higher than the tethering bandwidth and is closer to the tethering bandwidth than the bandwidth of the currently used cellular mode, the flow enters Step 308.

In Step 308, if the power manager 116 determines anew cellular mode that is more suitable than the current cellular mode in Step 306, the cellular configuration manager 114 controls the cellular modem 112 to change the cellular mode by using the new cellular mode.

In Step 310, the cellular configuration manager 114 continues to receive the tethering parameters from the tethering manager 116, and determines if one or more tethering parameters information change or update, or the cellular configuration manager 114 determines if a time set by a timer has expired (e.g., time counts down from a preset time to zero), if yes, the flow goes back to Step 306 to determine if any other cellular mode is more suitable; and if not, the flow enters Step 312 to use the current cellular mode, and then the flow enters Step 310 to determine if the tethering parameters have been updated or the time set by the timer has expired. In this embodiment, since the communications between the tethering device 100 and the electronic device 102 may be changed, and the tethering parameters may be changed accordingly, so the cellular configuration manager 114 can be triggered by the update of the tethering parameters to check check whether any other cellular mode is more suitable for the tethering device 100 than the currently used cellular mode, or the cellular configuration manager 114 can periodically check whether any other cellular mode is more suitable for the tethering device 100 than the currently used cellular mode, to dynamically determine the most suitable cellular mode to optimize the operations of the tethering device 100.

Briefly summarized, in the present invention, the tethering device can dynamically determine a suitable cellular mode according to the current tethering parameters of the network interface(s) of the tethering device, so that the cellular bandwidth will be closer to the tethering bandwidth between the tethering device and another electronic device, to improve the power consumption of the tethering device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A controller of a tethering device, comprising:
a tethering manager, configured to generating tethering parameters of at least one network interface of the tethering device, wherein the at least one network interface of the tethering device is used to communicate with an electronic device, and the electronic device shares a cellular network of the tethering device via the at least one network interface; and
a cellular configuration manager, coupled to the tethering manager, configured to determine a first cellular mode according to the tethering parameters of at least one network interface, to control a cellular modulator-demodulator (modem) to use the first cellular mode.

2. The controller of claim 1, wherein the at least one network interface comprises a Wi-Fi interface, the tethering parameters comprise Wi-Fi tethering parameters, and the Wi-Fi tethering parameters comprise an antenna mode, a channel width and/or a band currently used by the Wi-Fi interface.

3. The controller of claim 1, wherein the at least one network interface comprises an Universal Serial Bus (USB) interface, the tethering parameters comprise USB tethering parameters, and the USB tethering parameters comprise a connection type, a speed mode, and/or transfer queue parameters currently used by the USB interface.

4. The controller of claim 1, wherein the at least one network interface comprises an Ethernet interface, the tethering parameters comprise Ethernet tethering parameters, and the Ethernet tethering parameters comprise a cable type, transfer queue parameters, and/or if operating in a low power mode for the Ethernet interface.

5. The controller of claim 1, wherein the cellular configuration manager determines the first cellular mode whose corresponding bandwidth is closest and/or higher than a tethering bandwidth of the at least one network interface from a plurality of cellular modes.

6. The controller of claim 5, wherein the cellular configuration manager estimates or calculates the tethering bandwidth of the at least one network interface according to the tethering parameters, and determines the first cellular mode whose corresponding bandwidth is closest and higher than the tethering bandwidth of the at least one network interface from the plurality of cellular modes.

7. The controller of claim 5, wherein the plurality of cellular modes comprise different combinations of at least part of radio access technology (RAT), bands/frequencies, carrier aggregation (CA) modes, connection techniques and antenna configurations.

8. The controller of claim 1, wherein if the tethering parameters of the at least one network interface are updated, the cellular configuration manager dynamically determines a second cellular mode according to the updated tethering parameters of the at least one network interface, to control the cellular modem to use the second cellular mode.

9. The controller of claim 8, wherein the cellular configuration manager determines the second cellular mode whose corresponding bandwidth is closest and/or higher than a tethering bandwidth of the at least one network interface from a plurality of cellular modes.

10. A control method of a tethering device, comprising:
generating tethering parameters of at least one network interface of the tethering device, wherein the at least one network interface of the tethering device is used to communicate with an electronic device, and the electronic device shares a cellular network of the tethering device via the at least one network interface; and
determining a first cellular mode according to the tethering parameters of at least one network interface, to control a cellular modulator-demodulator (modem) to use the first cellular mode.

11. The control method of claim 10, wherein the at least one network interface comprises a Wi-Fi interface, the tethering parameters comprise Wi-Fi tethering parameters, and the Wi-Fi tethering parameters comprise an antenna mode, a channel width and/or a band currently used by the Wi-Fi interface.

12. The control method of claim 10, wherein the at least one network interface comprises an Universal Serial Bus (USB) interface, the tethering parameters comprise USB tethering parameters, and the USB tethering parameters comprise a connection type, a speed mode, and/or transfer queue parameters currently used by the USB interface.

13. The control method of claim 10, wherein the at least one network interface comprises an Ethernet interface, the tethering parameters comprise Ethernet tethering parameters, and the Ethernet tethering parameters comprise a cable type, transfer queue parameters, and/or if operating in a low power mode for the Ethernet interface.

14. The control method of claim 10, wherein the step of determining the first cellular mode according to the tethering parameters of the at least one network interface comprises:
determining the first cellular mode whose corresponding bandwidth is closest and/or higher than a tethering bandwidth of the at least one network interface from a plurality of cellular modes.

15. The control method of claim 14, wherein the step of determining the first cellular mode whose corresponding bandwidth is closest and/or higher than the tethering bandwidth of the at least one network interface from the plurality of cellular modes comprises:
estimating or calculating the tethering bandwidth of the at least one network interface according to the tethering parameters; and
determining the first cellular mode whose corresponding bandwidth is closest and higher than the tethering bandwidth of the at least one network interface from the plurality of cellular modes.

16. The control method of claim 14, wherein the plurality of cellular modes comprise different combinations of at least part of radio access technology (RAT), bands/frequencies, carrier aggregation (CA) modes, connection techniques and antenna configurations.

17. The control method of claim 10, further comprising:
if the tethering parameters of the at least one network interface are updated, dynamically determining a second cellular mode according to the updated tethering parameters of the at least one network interface, to control the cellular modem to use the second cellular mode.

18. The control method of claim 17, wherein the step of dynamically determining the second cellular mode according to the updated tethering parameters of the at least one network interface comprises:
determining the second cellular mode whose corresponding bandwidth is closest and/or higher than a tethering bandwidth of the at least one network interface from a plurality of cellular modes.
